(19) United States
(12) Patent Application Publication
(10) Pub. No.: US 2013/0106335 A1
(43) Pub. Date: May 2, 2013

(54) MOTOR DRIVE AND A METHOD OF CONFIGURING A MOTOR DRIVE

(71) Applicant: ABB Oy, Helsinki (FI)

(72) Inventor: Jarmo-Matti UUSI-ÄIJÖ, Espoo (FI)

(73) Assignee: ABB Oy, Helsinki (FI)

(21) Appl. No.: 13/666,436

(22) Filed: Nov. 1, 2012

(30) Foreign Application Priority Data
Nov. 1, 2011 (EP) 11187379.0

(51) Int. Cl. H02P 31/00

(52) U.S. Cl. 318/494

(57) ABSTRACT

The disclosure relates to a motor drive including electric power supply devices for supplying electric power to an electric motor, a memory for storing parameters, a controller for controlling the power supply according to the parameters stored in the memory, and an interface for connecting a computer to the motor drive. In order to enhance configuration of the motor drive, a configuration program is stored in the memory, and the interface provides the computer with access to the memory for executing the configuration program with the computer and for changing the parameters stored in the memory with the computer executing the configuration program.

### RELATED APPLICATION

This application claims priority under 35 U.S.C. §119 to European Patent Application No. 11187379.0 filed in Europe on Nov. 1, 2011, the entire content of which is hereby incorporated by reference in its entirety.

### FIELD

This disclosure relates to a motor drive and to configuring a motor drive.

### BACKGROUND INFORMATION

A motor drive can control the supply of electric power to an electric motor on the basis of parameters stored in a memory of the drive. A number of parameters defining how the electric power supply can be carried out may be large, and therefore the configuration of the drive, for example, the storage of the correct parameters into the memory, can be cumbersome.

An external computer can be used for configuring a motor drive. The computer can be connected to the drive via an interface. A program installed on the computer can then be executed in order to access parameters stored in a memory of the motor drive and to change these stored parameters. However, the number of different types of motor drives is large. The configuration capabilities can be different for different types of motor drives and therefore the configuration of a particular type of motor drive can involve a configuration program suitable for the type of motor drive in question.

A known method for configuring different types of drives is to download and install on the computer a configuration program that is suitable for the drive type in question. After this installation process, the computer can be connected to the motor drive in order to initiate the configuration. This can be a slow and cumbersome method.

### SUMMARY

A motor drive is disclosed, comprising electric power supply devices for supplying electric power to an electric motor, a memory for storing parameters, a controller for controlling supplied electric power of the electric power supply devices according to the parameters stored in the memory and an interface for connecting a computer to the motor drive, wherein a configuration program is stored in the memory, and the interface provides the computer with access to the memory for executing the configuration program with the computer and for changing the parameters stored in the memory with the computer executing the configuration program.

A method is disclosed for configuring a motor drive with power supply devices for supplying electric power to an electric motor according to parameters stored in a memory of the motor drive, wherein the method comprises connecting a computer via an interface to the motor drive, executing a configuration program stored in the memory of the motor drive with the computer, and changing the parameters stored in the memory of the motor drive with the configuration program executed by the computer.

### BRIEF DESCRIPTION OF THE DRAWINGS

In the following, the present disclosure will be described in closer detail by way of example and with reference to the attached drawings, in which:

FIG. 1 is a block diagram of a motor drive according to an exemplary embodiment of the disclosure;

FIG. 2 is a flow chart of a method for configuring a motor drive according to an exemplary embodiment of the disclosure; and

FIG. 3 illustrates memory content in a motor drive according to an exemplary embodiment of the disclosure.

### DETAILED DESCRIPTION

The possibility of accessing a configuration program stored in a memory of a motor drive such that the computer used for configuration can execute this program can simplify the configuration. In such a case, it is sufficient to ensure that the motor drive has the correct version of the configuration program stored in its memory so that practically any computer can be directly used for configuration of the motor drive.

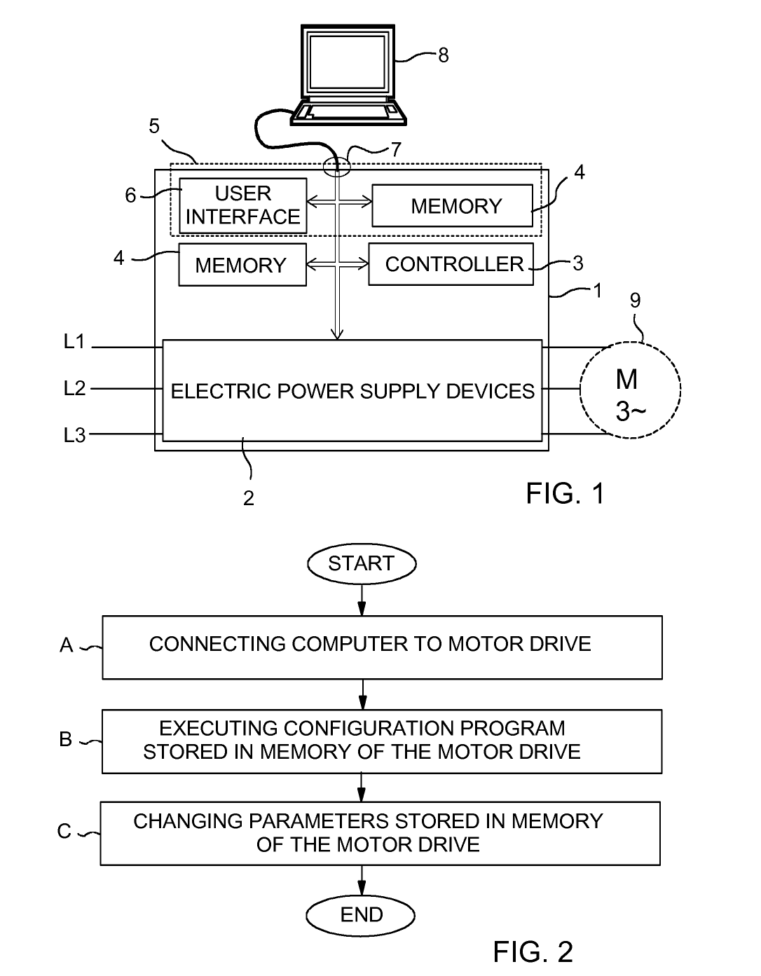

FIG. 1 illustrates a first exemplary embodiment of a motor drive 1, such as a frequency converter, and FIG. 2 illustrates an exemplary method according to the disclosure of configuring the motor drive of FIG. 1. The motor drive 1 of FIG. 1 includes electric power supply devices 2 which, controlled by a controller 3, can supply electric power to an electric motor 9. However, electric power supply devices 2 can include for example, a rectifier, an intermediate circuit for filtering by a low-pass filter a pulsating direct voltage received from the rectifier or for converting such a voltage into direct current by a smoothing choke, and an inverter which converts the direct current of the intermediate circuit into an alternating current of a desired frequency.

In the example of FIG. 1, the controller 3 can utilize parameters stored in a memory 4 for controlling the power supply provided by the power supply devices 2 to the electric motor 9. The memory 4 can be implemented as one or more memory circuits, for example. In FIG. 1 two memory circuits are illustrated by way of example. A control program can be provided as a computer-readable computer program product, such as, e.g., a computer readable non-transitionary recording medium on which the control program is recorded or stored. The computer-readable recording medium can be, e.g., a CD-ROM, a DVD, a solid-state memory, a computer hard drive, RAM, or other types of memories that are readily removable or intended to remain fixed within the computer.

FIG. 1 shows that the motor drive 1 can also include an operation panel 5 provided with a user interface 6 and a memory 4. The user interface 6 can include a display and a keyboard. However, no such operation panel is necessary in all embodiments. If such an operation panel 5 is present in the motor drive 1, it can be used for browsing and changing parameters stored in the memory 4 of the motor drive in order to affect how the power supply to the electric motor 9 is implemented.

In FIG. 1, the motor drive 1 includes an interface 7 which can be utilized in method step A of FIG. 2 to connect a computer 8 (such as a laptop) to the motor drive 1. The interface can be a USB (Universal Serial Bus) interface of type 2.0 or 3.0, for example, and it can be arranged in the operation panel 5, if such an operation panel exists. This interface 7 provides the computer 8 with access to the memory 4 of the operation panel 5, for example. In this memory circuit (or alternatively in another memory circuit of the motor drive to which the computer 8 is provided access via interface 7), a configuration program has been stored. The storing can take place in connection with manufacturing of the motor drive, for example, which makes it possible to ensure that the configuration program is exactly the correct version for this motor drive. Consequently, the computer 8 can, in method step B of FIG. 2, access the configuration program via the interface 8 and execute this program. While the program is running on the computer 8, the user of the computer can, in method step C, utilize the display and keyboard of the computer in order to browse and change the parameters stored in the memory 4 of the motor drive, and therefore to change how the motor drive operates while providing electric power to the electric motor 9.

An advantage obtained with the above-described method of executing the configuration program with the external computer 8 is that the need of downloading and installing a configuration program from an external source to the computer 8 before this computer can be used to configure the motor drive can be avoided. Consequently, practically any computer can, without a need for prior software installations, be utilized for configuring the motor drive via the interface 7. One example is to utilize a configuration program compatible with the .NET environment provided by Microsoft or with the JAVA environment provided by Oracle, and which, in practise, is available on a great number of computers.

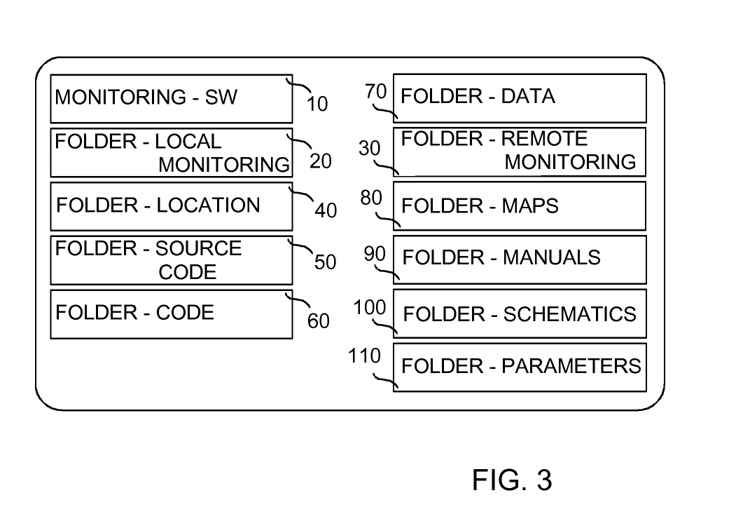

Storage of the configuration program in the operation panel makes it possible to improve the user friendliness. In that case the configuration program stored in the operation panel can also be accessed by a computer connected to the operation panel, while the operation panel is not attached or connected to the motor drive. The interface 6 (such as, for example, an USB interface) can in such a method be used for electrifying the operation panel at least partially with electric power from the computer such that no additional power source is needed for the panel. In that case, if the panel contains the parameters of the motor drive (such as described in connection with folder 110 of FIG. 3), parameters can be changed and stored into the portable panel at an office desk, for example, instead of at the installation site of the motor drive only. After such configuration at a remote location, the panel can be transported to the installation site of the motor drive and attached to the motor drive. Also in this case configuration can be carried out without a need for downloading and installing a configuration program to the computer in advance, as the configuration program needed can be obtained from the memory of the panel which is being configured. After the operation panel has been connected to the motor drive, the parameters can be transferred into the motor drive and in this way been taken into use.

In addition, it is also possible to store a monitoring program in a memory 4 of the motor drive such that this monitoring program can be executed by the computer 8 while it is connected to the motor drive via the interface 7. Such a monitoring program can be a part of the configuration program or alternatively a separate independent program. Once the monitoring program is executed and the motor drive is active (supplies power to the electric motor), the monitoring program can be used to obtain monitoring data from the motor drive to the computer that describes the operational status of the motor drive, the electric motor, and the environment, for example. Such monitoring data can be analysed with the computer 8 or alternatively transferred to another computer with software specifically designed for more thorough analysis of the monitoring data.

The motor drive 1 and (if available), for example, the operation panel 5 of the motor drive can be configured to independently carry out monitoring of the motor drive during operation of the motor drive 1 by storing monitoring data in the memory 4. Such monitoring can be initiated via the operation panel or via a computer connected to the motor drive, though the computer may not necessarily be connected to the motor drive 1 during the entire monitoring. Instead, the computer can be disconnected, the motor drive 1 continues with the monitoring, and once the computer 8 is reconnected to the motor drive, the monitoring data can be transferred to the computer via the interface 7.

In order to facilitate efficient maintenance of the motor drive, two different versions of the configuration program can exist. The version stored in the memory of the motor drive can be a Light version, which facilitates basic configuration and possibly also monitoring tasks, as described previously. In addition to this Light version, which can be executed directly with any computer connected to the motor drive without requiring prior downloading and installation on the program (from an external source), a Pro version can exist. In that case, the Pro version may work as a management tool, which, in addition to configuration and monitoring, makes it possible to update programs and other data stored in the memory of the drive. Such a Pro version can be distributed to specialized maintenance personnel only, for instance, and it requires advance downloading and installation on the computer which is subsequently connected to the motor drive. This Pro version can be used to update the version of the configuration program and monitoring program stored in the memory of the motor drive, for example.

FIG. 3 illustrates memory content in an exemplary embodiment of a motor drive according to the disclosure. In the following it is by way of example assumed that FIG. 3 illustrates the content of the memory circuit 4 of the operation panel 5 illustrated in FIG. 1.

Folder 10 contains the monitoring program which can be executed by the computer while it is connected to the motor drive. In this example, the monitoring program is assumed to be a standalone monitoring software. The same, or alternatively, a second monitoring program stored in this folder can be used by the operation panel working as a monitoring master in order to carry out monitoring while no external computer is connected to the motor drive. Updating of the monitoring program or monitoring programs can be carried out with the previously mentioned PRO version of the configuration program.

Folder 20 is used for storing monitoring data when the monitoring is done while no external computer is connected to the motor drive. The monitoring can be started using a computer connection and then the computer can be detached and the operation panel preforms monitoring by itself. Monitoring can also be started with limited functionality using the user interface 6 of the operation panel 5. Later on, monitoring data can be collected from the memory circuit of the panel by connecting a computer to the operation panel.

Folder 30 is used by the operation panel for storing monitoring data when the monitoring is done with a computer connection. Monitoring data can be stored directly to the operation panel. Monitoring data can also be stored directly to a computer connected to the motor drive or operation panel. In that case it is not necessary to store monitoring data in folder 30. However, it is possible that monitoring data is stored both in the folder 30 and in the computer connected to the motor drive or operation panel.

Folder 40 is used for storing information about the location where the motor drive is installed. Such information can include, for example: city, street, building, department, floor, room and cabinet.

If more advanced programming is done in the motor drive, information about the source code and source code of the program can be stored in folder 50. All the programming can be carried out with the PRO version of the configuration program. It is not necessary that the computer used is connected to the panel during the programming. The source code can be copied to folder 50 using the Light version or the PRO version of the configuration program.

If a programming code needs to be compiled to a runtime-code, the compiled code can be stored in folder 60. This folder 60 can then be used as a backup restore source in case there is a major breakdown of the drive. Compiled files can be moved using the Light version or the PRO version of the configuration program.

Other data such as temporarily stored runtime operation panel related data and operation panel firmware software can be stored in folder 70. Panel firmware and other configuration files in this folder 70 are only for backup purpose and are not directly in use by the panel. Panel firmware and configuration files can be restored from folder 70 by using the PRO version of the configuration program.

Folder 80 can contain road maps covering the location of the motor drive, location maps, building and campus maps, and possible other material related to maps.

Folder 90 can contain manuals, such as an installation manual, a programming manual, a panel manual, a configuration program manual and other documents which can be categorized as manuals. Manuals can be transferred and updated in folder 90 by using the Light version or the PRO version of the configuration program.

Folder 100 can contain installation schematics of the motor drive. If the motor drive is a part of a bigger system, full system schematics can be stored in here. The information contained in folder 100 can be moved between the motor drive and a computer connected to the motor drive by using the Light version of the PRO version of the configuration program.

Folder 110 can contain parameter settings. In order to achieve faster parameter configuration, parameters can be copied into this folder 110 and then the new set of parameters can be taken into use after a control board restart. More advanced runtime parameter reconfiguration may be carried out without a restart. Parameters can be stored into folder 110 and moved from folder 110 by using the operation panel and the Light version or PRO version of the configuration program. A timestamp may be maintained for a parameter copy.

Exemplary embodiments of the present disclosure have been described with respect to the operative features the structural components perform. The exemplary embodiments of the present disclosure can also be implemented by at least one processor (e.g., general purpose or application specific) of a computer processing device which is configured to execute a computer program tangibly recorded on a non-transitory computer-readable recording medium, such as a hard disk drive, flash memory, optical memory or any other type of non-volatile memory. Upon executing the program, the at least one processor is configured to perform the operative functions of the above-described exemplary embodiments.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A motor drive, comprising:
electric power supply devices for supplying electric power to an electric motor;
a memory for storing parameters;
a controller for controlling supplied electric power of the electric power supply devices according to the parameters stored in the memory; and
an interface for connecting a computer to the motor drive, wherein:
a configuration program is stored in the memory; and
the interface provides the computer with access to the memory for executing the configuration program with the computer and for changing the parameters stored in the memory with the computer executing the configuration program.

2. The motor drive according to claim 1, wherein the memory of the motor drive comprises:
a plurality of memory circuits arranged at different locations in the motor drive.

3. The motor drive according to claim 1, comprising:
an operation panel with a user interface, wherein the configuration program is stored in a memory circuit of the operation panel.

4. The motor drive according to claim 1, wherein the interface providing the computer with access to the memory is a USB interface.

5. The motor drive according to claim 1, comprising:
a monitoring program stored in the memory, wherein the interface provides the computer with access to the memory for executing the monitoring program with the computer and for receiving monitoring data for describing an operating status of the motor drive during operation.

6. The motor drive according to claim 5, wherein the monitoring program and the configuration program are one single executable program stored in the memory.

7. The motor drive according to claim 1, wherein the motor drive is configured to carry out monitoring during operation of the motor drive by storing monitoring data describing an operating status of the motor drive in the memory, and to provide the computer with the monitoring data stored in the memory when the computer is reconnected to the motor drive via the interface.

8. A method for configuring a motor drive with power supply devices for supplying electric power to an electric motor according to parameters stored in a memory of the motor drive, wherein the method comprises:
connecting a computer via an interface to the motor drive;
executing a configuration program stored in the memory of the motor drive with the computer; and
changing the parameters stored in the memory of the motor drive with the configuration program executed by the computer.
